(19) United States
(12) Patent Application Publication
(10) Pub. No.: US 2026/0156144 A1
(43) Pub. Date: Jun. 4, 2026

(54) SYSTEM AND METHOD FOR INTELLIGENT CYBERSECURITY ANALYSIS USING ARTIFICIAL INTELLIGENCE

(71) Applicants: Ramesh JULAKANTI, Wesley Chapel, FL (US); Ram Reddy JONNALAGADDA, Wesley Chapel, FL (US)

(72) Inventors: Ramesh JULAKANTI, Wesley Chapel, FL (US); Ram Reddy JONNALAGADDA, Wesley Chapel, FL (US)

(21) Appl. No.: 19/457,312

(22) Filed: Jan. 23, 2026

(51) Int. Cl. H04L 9/40

(52) U.S. Cl. CPC H04L 63/1441; H04L 63/1416; H04L 63/1433

(57) ABSTRACT

The present invention relates to a system and method for intelligent cybersecurity analysis using artificial intelligence, wherein cybersecurity-related data generated across heterogeneous digital environments is continuously collected, processed, and analyzed to detect, assess, and mitigate cyber threats. The invention employs coordinated operation of hardware-supported processors and memory units to normalize multi-source telemetry, construct behavioral profiles of users, devices, applications, and network segments, and correlate events across multiple system layers. By applying adaptive artificial intelligence techniques, the system identifies deviations from learned behavioral patterns, computes dynamic risk values, and initiates appropriate mitigation actions in real time. The invention further incorporates continuous learning based on observed outcomes to improve detection accuracy and reduce false alerts over time.

### TECHNICAL FIELD OF THE INVENTION

The present invention relates generally to the field of cybersecurity and information assurance, and more particularly to an intelligent, computer-implemented cybersecurity system, method, and dedicated machine structure configured to analyze, detect, predict, and respond to cyber threats using artificial intelligence techniques operating on multi-layered digital, network, and behavioral data streams. The invention finds particular applicability in protecting enterprise computing infrastructures, cloud-based environments, industrial control systems, Internet-of-Things networks, and mission-critical digital assets from advanced and evolving cyber threats.

### BACKGROUND OF THE INVENTION

With the exponential growth of interconnected computing systems, cloud platforms, distributed databases, and intelligent devices, cybersecurity threats have increased significantly in complexity, frequency, and impact. Conventional cybersecurity solutions primarily rely on static rule-based detection mechanisms, signature matching techniques, and predefined threat intelligence feeds. While such systems can effectively identify known attack patterns, they are fundamentally limited in their ability to detect novel, zero-day, and polymorphic threats that dynamically evolve to evade predefined rules.

Existing intrusion detection and prevention systems typically operate in isolation at specific layers of the technology stack, such as network traffic monitoring, endpoint protection, or application-level security. These siloed approaches fail to correlate events across heterogeneous sources, resulting in incomplete threat visibility and delayed response. Moreover, traditional security analytics systems often generate excessive false positives, overwhelming security teams and reducing the effectiveness of threat mitigation strategies.

Advanced persistent threats increasingly exploit behavioral anomalies, lateral movement patterns, credential misuse, and subtle deviations in system operations that are difficult to detect using deterministic logic. Current systems lack the capability to continuously learn from operational data, adapt to evolving attack surfaces, and autonomously refine detection models without manual intervention. Additionally, most existing cybersecurity platforms depend heavily on human analysts for incident triage, forensic analysis, and response orchestration, leading to slower reaction times and increased risk exposure.

Accordingly, there exists a critical need for an intelligent cybersecurity solution that can autonomously analyze large-scale heterogeneous data, learn normal and malicious behaviors, detect both known and unknown threats in real time, and execute adaptive response actions. Such a solution must be implemented as a technical system supported by dedicated computing hardware and structured data processing architectures, thereby providing a concrete technical effect in enhancing cybersecurity resilience.

The rapid expansion of interconnected digital infrastructure across enterprises, governments, and critical industries has created a cybersecurity environment in which the attack surface grows continuously while adversarial techniques evolve at a faster pace than conventional defensive updates. Modern computing environments are no longer confined to a single perimeter network protected by a gateway firewall, but instead span hybrid cloud deployments, multi-cloud workloads, containerized applications, remote endpoints, mobile devices, operational technology networks, and Internet-of-Things devices. Each layer generates large volumes of telemetry, including packet metadata, authentication events, endpoint process activity, system calls, application logs, database queries, identity and access management traces, and cloud control-plane events. While this telemetry contains valuable indicators of compromise and subtle precursors of intrusion, it is typically heterogeneous in schema and granularity, dispersed across tools, and produced at a volume that exceeds manual analysis capacity. Consequently, organizations face persistent gaps in visibility, delayed detection, and inconsistent response, especially when threats intentionally remain low-noise and distributed over time.

Existing cybersecurity solutions have historically relied on signature-based detection, deterministic rules, and curated threat intelligence indicators such as known malicious hashes, domain names, and Internet Protocol addresses. Antivirus and traditional intrusion detection systems exemplify this approach by matching observed artifacts to previously cataloged patterns. These systems can be effective against known malware families and repetitive exploit chains, yet they suffer from fundamental limitations in detecting new threats that have not been previously observed or that have been modified to evade pattern matching. Attackers frequently employ polymorphism, packing, encryption, and fileless techniques that minimize static signatures. Similarly, network intrusion detection tools that depend on packet payload inspection or known protocol exploit sequences struggle when traffic is encrypted end-to-end, when attackers use legitimate cloud services as command-and-control relays, or when malicious actions are embedded within normal application traffic. The operational result is that signature systems tend to miss novel attacks while producing a steady stream of low-confidence alerts that require extensive human triage.

Rule-based security information and event management systems attempt to improve detection by aggregating logs and applying correlation rules defined by security engineers. These rules may detect known sequences, such as repeated failed logins followed by a successful login from a new location, or unusual administrative group membership changes. However, rule authoring is time-consuming, requires domain expertise, and becomes brittle as environments change. Dynamic enterprise networks add new applications, services, and user patterns frequently, causing previously effective rules to generate false positives or become obsolete. Rule-based correlation also tends to be limited by the rule writer's assumptions, resulting in a narrow coverage of attack strategies. In complex multi-stage intrusions, adversaries intentionally fragment actions across hosts and time intervals to avoid triggering deterministic thresholds. Rule systems also commonly fail to model entity context, such as the normal behavior of a particular service account, the expected network pathways between specific workloads, or the permitted operational patterns of industrial controllers. As a result, these systems may over-alert on benign anomalies while missing slow-moving lateral movement, privilege escalation, and data staging behaviors.

Endpoint detection and response tools have become a principal component of modern security stacks by collecting detailed endpoint telemetry such as process creation, command line activity, memory events, file operations, registry modifications, and network connections. Such tools often incorporate behavioral heuristics and analytics to identify suspicious sequences. Nevertheless, endpoint solutions still face challenges in environments with diverse operating systems, unmanaged devices, and constrained legacy systems. Endpoint telemetry is also data-intensive, and organizations may reduce collection fidelity due to storage and cost constraints, weakening detection quality. Moreover, sophisticated attackers increasingly use legitimate system tools, living-off-the-land binaries, and native administration utilities to blend into normal activity. Behavioral heuristics that flag these tools frequently generate high false positive rates, especially in IT-heavy organizations where administrative scripts are common. Endpoint systems also may struggle to unify endpoint events with identity, cloud, and network context in a way that produces a coherent incident narrative without significant manual correlation.

Network traffic analysis and anomaly detection solutions attempt to address encrypted traffic limitations by focusing on metadata, flow analysis, and statistical deviations. These approaches analyze features such as flow duration, packet size distributions, connection frequency, and destination reputation. While metadata analysis is valuable, it is also inherently ambiguous. Many benign applications exhibit bursty traffic, unusual destination patterns, or non-standard protocols. Without robust context and entity baselines, anomaly detection frequently produces non-actionable alerts. Additionally, network traffic visibility can be incomplete in modern architectures that route traffic internally within cloud virtual networks, service meshes, or container overlay networks, where traditional sensors cannot easily observe east-west movement. When visibility gaps exist, network analytics may detect only partial segments of an intrusion, reducing confidence and slowing response.

User and entity behavior analytics solutions are designed to establish baselines for users, service accounts, devices, and applications, and then flag deviations such as abnormal login times, unusual resource access, or atypical data transfer patterns. Although these systems represent progress beyond static rules, they often depend on simplified models that assume stability of behavior over time. In reality, user behavior changes with organizational roles, seasonal projects, remote work schedules, and evolving operational needs. Baseline drift and concept drift can cause the system to treat legitimate changes as suspicious, again increasing false positives. Conversely, attackers may intentionally mimic normal user patterns by accessing resources slowly, using normal working hours, and leveraging compromised legitimate credentials, thereby reducing the visibility of deviations. Many behavior analytics tools also rely on limited feature sets due to integration constraints, and therefore miss deep signals such as fine-grained process lineage, command intent, lateral movement graph structure, or multi-step correlations across identity and cloud layers.

Threat intelligence platforms and automated enrichment services provide context by linking observed indicators to external feeds, vulnerability databases, and known adversary tactics. While this enrichment can speed investigation, it remains reactive, dependent on the availability and freshness of external information, and often biased toward well-known threats. Novel attacker infrastructure can appear and disappear rapidly, and attackers increasingly use reputable cloud providers, content delivery networks, and compromised legitimate domains to avoid reputation-based blocking. Enrichment can also create a false sense of certainty; an indicator may be unknown not because it is benign but because it has not yet been reported. In addition, threat intelligence integration often increases system complexity and can create noisy associations that require skilled analysts to interpret.

Security orchestration and automated response systems aim to reduce incident response time by automating actions such as ticketing, isolation, blocking, and credential resets. However, the effectiveness of automation depends heavily on the accuracy of upstream detections. In environments with high false positives, aggressive automation can disrupt business operations, causing organizations to restrict automation to low-impact actions, which reduces its protective value. Furthermore, many orchestration tools operate through predefined playbooks, which, like rule-based detection, require continuous maintenance and may not adapt well to novel attack sequences. When incidents involve stealthy or ambiguous behaviors, orchestration systems often require human approval, negating speed advantages.

Machine learning has been introduced into security products to improve detection, but many existing implementations are constrained by limited training data, narrow scope, or opaque decision-making. Supervised learning approaches require labeled datasets that are expensive to curate and often unrepresentative of an organization's specific environment. Models trained on generic datasets may not generalize to unique enterprise workflows, producing either missed detections or excessive false alarms. Unsupervised learning approaches, while less dependent on labels, can be unstable and sensitive to configuration and data quality. Additionally, many machine learning-based security systems lack robust mechanisms for continual learning under real-world drift, resulting in degraded performance over time unless retrained manually. The interpretability of machine learning decisions is also a persistent challenge; security operators require actionable explanations, such as which features drove a risk score and what causal chain of events is suspected, but many models output scores without providing sufficient forensic transparency. This lack of explainability slows investigations and reduces trust in automated recommendations.

Another significant drawback of existing solutions is the fragmentation of security telemetry across multiple vendors and tools, leading to duplicated data, inconsistent identity resolution, and difficulty correlating events into coherent attack narratives. A single intrusion can involve phishing, credential theft, anomalous cloud API calls, endpoint persistence, lateral movement, and data exfiltration. When each stage is monitored by different tools with different schemas and time bases, the analyst must manually stitch evidence together, extending dwell time. Moreover, many environments suffer from incomplete coverage due to cost and deployment constraints, leaving blind spots that adversaries exploit. Even where coverage exists, high volumes of raw events can overwhelm storage and processing resources, forcing organizations to downsample logs or shorten retention periods, which impairs retrospective analysis and incident reconstruction.

Accordingly, the technical landscape demonstrates a persistent need for an intelligent cybersecurity analysis approach that can unify multi-source telemetry, perform accurate cross-domain correlation, learn entity-specific behavioral baselines, adapt continuously to drift and environmental changes, reduce false positives through contextual reasoning, and provide actionable outputs suitable for automated mitigation without undue operational disruption. Existing solutions, while valuable in isolated scenarios, remain limited by static signatures, brittle rules, insufficient context, high alert noise, inadequate adaptation to novel threats, and a lack of end-to-end integration that produces reliable, real-time detection and response in modern distributed computing environments.

### SUMMARY OF THE INVENTION

The present invention addresses the aforementioned limitations by providing a system and method for intelligent cybersecurity analysis using artificial intelligence, along with a dedicated cybersecurity analysis device configured as a machine structure. The invention employs multiple cooperating processors, memory units, communication interfaces, and artificial intelligence processing units to continuously collect, process, correlate, and analyze cybersecurity-relevant data across network, system, application, and user activity layers.

The system is designed to generate multi-dimensional behavioral representations of digital entities, including users, devices, applications, and network segments, and to apply machine learning and deep learning techniques to identify deviations indicative of cyber threats. The method further enables predictive threat assessment, adaptive risk scoring, and automated response execution based on learned threat patterns and contextual intelligence.

By implementing continuous learning mechanisms and dynamic model adaptation, the invention achieves improved detection accuracy, reduced false positives, faster response times, and enhanced protection against sophisticated and previously unseen cyberattacks.

An object of the present invention is to provide an intelligent cybersecurity system and method capable of continuously analyzing large volumes of heterogeneous cybersecurity data generated across network infrastructure, computing devices, applications, cloud services, and user interactions, in order to achieve comprehensive and unified threat visibility that overcomes the fragmentation and silos present in existing security solutions. The invention seeks to establish a technically integrated approach in which diverse telemetry sources are correlated in real time to produce a coherent and context-aware understanding of system behavior.

Another object of the invention is to enable accurate detection of both known and unknown cyber threats through the use of artificial intelligence techniques that learn normal operational and behavioral patterns of digital entities and identify deviations indicative of malicious activity. The invention aims to move beyond static signature matching and predefined rules by providing adaptive behavioral analysis that evolves with changes in infrastructure, user behavior, and application workloads, thereby improving detection capability against zero-day attacks, insider threats, and advanced persistent threats.

A further object of the invention is to reduce false positives and alert fatigue commonly associated with conventional cybersecurity systems by applying contextual reasoning, multi-source event correlation, and dynamic risk scoring. By evaluating anomalies in relation to entity-specific baselines, asset criticality, temporal patterns, and correlated activity sequences, the invention seeks to ensure that alerts generated by the system are meaningful, prioritized, and actionable, thereby improving operational efficiency and decision-making for security operations.

Another object of the invention is to provide predictive cybersecurity analysis by identifying early indicators of compromise and attack progression before a full-scale incident occurs. The invention is intended to assess threat likelihood and potential impact in advance, enabling proactive mitigation actions that reduce attack dwell time and limit damage to critical systems and data.

An additional object of the invention is to automate and optimize cybersecurity response actions in a controlled and adaptive manner, based on computed risk levels and learned response outcomes. The invention seeks to enable timely execution of mitigation measures such as access restriction, system isolation, and alerting while minimizing disruption to legitimate operations, thereby balancing security enforcement with system availability and performance.

Another object of the invention is to incorporate continuous learning mechanisms that refine artificial intelligence models based on newly observed data, confirmed incidents, and response effectiveness. The invention aims to ensure long-term accuracy and resilience of the cybersecurity analysis by adapting to evolving threat techniques and environmental changes without requiring constant manual reconfiguration or rule updates.

A further object of the invention is to provide a dedicated cybersecurity analysis device and machine structure in which the analytical processes are executed using tangible computing hardware including processors, memory units, and communication interfaces. The invention seeks to deliver cybersecurity analysis as a concrete technical solution implemented through hardware-supported data processing rather than as an abstract or purely software-based concept.

Another object of the invention is to enhance scalability and performance of cybersecurity analysis in large and complex environments by distributing computational workloads efficiently across processing units and enabling real-time analysis of high-velocity data streams. The invention aims to maintain consistent detection accuracy and response speed even as the volume and diversity of monitored data increase.

An additional object of the invention is to provide explainable and traceable cybersecurity decisions by associating detected threats with correlated events, behavioral deviations, and risk factors. The invention seeks to support forensic analysis, compliance requirements, and operator trust by enabling visibility into the basis of threat determinations and response actions.

A further object of the invention is to improve overall cyber resilience of digital systems by reducing attack dwell time, limiting lateral movement, preventing data exfiltration, and strengthening defensive posture through intelligent, adaptive, and autonomous cybersecurity analysis.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for intelligent cybersecurity analysis using artificial intelligence; and

FIG. 2 displays flow chart of a method for intelligent cybersecurity analysis using artificial intelligence.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

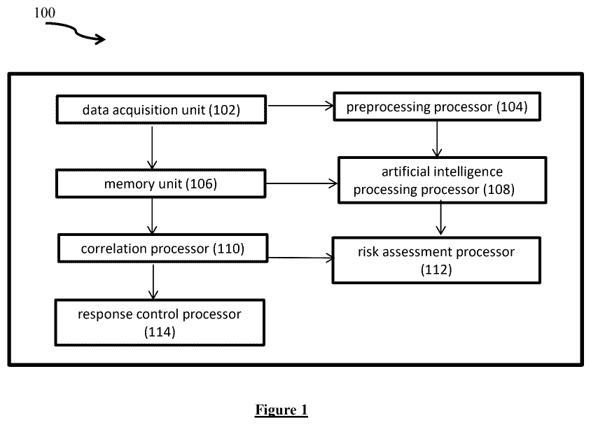

Referring to FIG. 1, a block diagram of a system for intelligent cybersecurity analysis using artificial intelligence is illustrated. The system 100 comprises: a data acquisition unit (102) configured to receive cybersecurity-related data streams from a plurality of heterogeneous digital sources including network communication interfaces, computing devices, application execution environments, identity management services, and data storage systems; a preprocessing processor (104) operatively coupled to the data acquisition unit and configured to normalize the received cybersecurity-related data by performing time synchronization, format standardization, entity resolution, and noise filtering to generate structured event representations; a memory unit (106) configured to store the structured event representations and historical behavioral data associated with monitored entities; an artificial intelligence processing processor (108) operatively coupled to the memory unit and configured to generate and maintain behavioral profiles corresponding to users, devices, applications, and network segments by learning normal operational patterns from the historical behavioral data; a correlation processor (110) configured to analyze temporal, contextual, and relational dependencies among the structured event representations across the plurality of digital sources to identify multi-stage and cross-domain activity sequences; a risk assessment processor (112) configured to compute dynamic risk values for identified activity sequences based on deviation from learned behavioral profiles, contextual relevance, and asset sensitivity; and a response control processor (114) configured to initiate cybersecurity mitigation actions when the computed dynamic risk values satisfy predefined or adaptively learned thresholds, wherein the system continuously updates the behavioral profiles based on newly observed data and response outcomes to improve threat detection accuracy over time.

In an embodiment, the data acquisition unit (102) is configured to receive the cybersecurity-related data streams through secured communication interfaces employing encrypted data transfer and authenticated source verification to ensure integrity and authenticity of the received data.

In an embodiment, the preprocessing processor (104) is further configured to generate unified entity identifiers by correlating user credentials, device identifiers, network addresses, and application identifiers across different data sources, such that events originating from the same logical entity are associated with a common behavioral context.

In an embodiment, the artificial intelligence processing processor (108) is configured to construct the behavioral profiles by applying a combination of supervised learning techniques trained on labeled threat data and unsupervised learning techniques trained on unlabeled operational data to distinguish normal behavior patterns from anomalous behavior patterns.

In an embodiment, the artificial intelligence processing processor (108) is further configured to adapt the behavioral profiles over time by incorporating incremental learning based on observed changes in operational behavior while preserving historical context to prevent degradation of detection accuracy.

In an embodiment, the correlation processor (110) is configured to construct event relationship graphs representing interactions among entities, resources, and actions, and to analyze the event relationship graphs to identify lateral movement attempts, privilege escalation sequences, and coordinated attack behaviors spanning multiple system layers.

In an embodiment, the risk assessment processor (112) is configured to assign weighted significance values to different event attributes including frequency, duration, sequence order, and affected resource criticality, and to compute the dynamic risk values by aggregating the weighted significance values in relation to the learned behavioral profiles.

In an embodiment, the response control processor is configured to execute mitigation actions including restricting network connectivity, limiting access privileges, isolating computing devices, generating security alerts, or initiating remediation workflows, and wherein the mitigation actions are selected based on the computed dynamic risk values and predefined operational impact constraints.

In an embodiment, the response control processor (114) is further configured to record outcomes of executed mitigation actions and to provide feedback to the artificial intelligence processing processor, such that the behavioral profiles and risk computation logic are refined based on effectiveness of prior responses.

In an embodiment, the memory unit (106) comprises a combination of volatile memory and non-volatile storage configured to retain both short-term event data for real-time analysis and long-term historical data for behavioral learning and forensic investigation.

The system 100 is implemented as a modular computing platform in which the data acquisition unit (102) is realized as a combination of hardware network interface modules, embedded security connectors, log collection services, and application programming interface gateways configured to interface with heterogeneous digital environments and capable of handling high-throughput event ingestion, the preprocessing processor (104) is implemented as a dedicated data transformation engine executed on one or more multi-core processors and associated memory buffers and is configured with rule-based and statistical normalization modules for structuring incoming cybersecurity data, the memory unit (106) is implemented as a hybrid storage architecture comprising volatile memory for real-time event caching and non-volatile storage for historical behavior retention, the artificial intelligence processing processor (108) is implemented as a high-performance computing module equipped with parallel processing cores and machine-learning runtime libraries for constructing, storing, and updating behavioral models, the correlation processor (110) is implemented as a graph-based analysis engine operating on relational and temporal datasets for discovering inter-event dependencies across systems, the risk assessment processor (112) is implemented as a scoring and decision engine configured to evaluate contextual deviations and asset sensitivity to compute threat likelihood values, and the response control processor (114) is implemented as an orchestration and enforcement controller integrated with network, endpoint, and identity systems for executing cybersecurity response actions, wherein all components are interconnected through a high-speed internal communication bus and operate under control of a system-level execution framework to provide an integrated intelligent cybersecurity analysis platform.

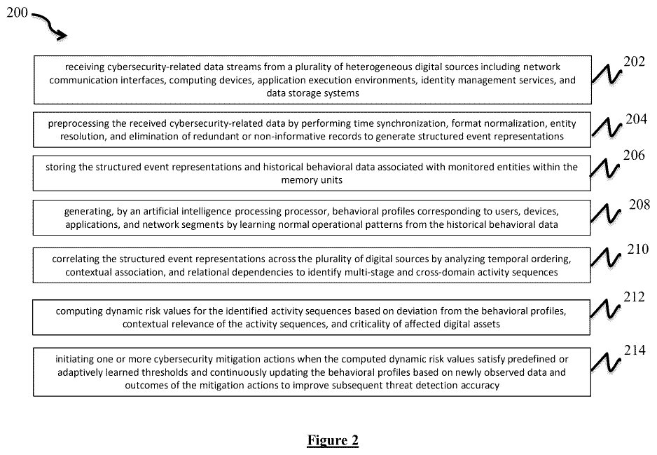

Referring to FIG. 2, a flow chart for a method for intelligent cybersecurity analysis using artificial intelligence, the method being executed by a computing system comprising one or more processors and memory units. The computing system executing the method is implemented as a distributed or single-node processing platform comprising one or more general-purpose processors, multi-core central processing units, graphical processing units, or specialized accelerators, operatively coupled to volatile and non-volatile memory units through a high-speed system bus, wherein the memory units store executable instructions, intermediate computation states, behavioral models, correlation structures, configuration parameters, and event data required by the method, and wherein the processors execute concurrent processing threads for data ingestion, preprocessing, behavioral modeling, correlation analysis, risk computation, and response orchestration, such that the computing system functions as an integrated execution environment capable of performing real-time cybersecurity analytics while supporting persistent learning, adaptive control logic, and scalable data processing across heterogeneous digital infrastructures.

The method 200 comprises:
At step 202, the method 200 includes receiving cybersecurity-related data streams from a plurality of heterogeneous digital sources including network communication interfaces, computing devices, application execution environments, identity management services, and data storage systems;
At step 204, the method 200 includes preprocessing the received cybersecurity-related data by performing time synchronization, format normalization, entity resolution, and elimination of redundant or non-informative records to generate structured event representations;
At step 206, the method 200 includes storing the structured event representations and historical behavioral data associated with monitored entities within the memory units;
At step 208, the method 200 includes generating, by an artificial intelligence processing processor, behavioral profiles corresponding to users, devices, applications, and network segments by learning normal operational patterns from the historical behavioral data;
At step 210, the method 200 includes correlating the structured event representations across the plurality of digital sources by analyzing temporal ordering, contextual association, and relational dependencies to identify multi-stage and cross-domain activity sequences;
At step 212, the method 200 includes computing dynamic risk values for the identified activity sequences based on deviation from the behavioral profiles, contextual relevance of the activity sequences, and criticality of affected digital assets; and
At step 214, the method 200 includes initiating one or more cybersecurity mitigation actions when the computed dynamic risk values satisfy predefined or adaptively learned thresholds; and continuously updating the behavioral profiles based on newly observed data and outcomes of the mitigation actions to improve subsequent threat detection accuracy.

In an embodiment, receiving the cybersecurity-related data streams comprises acquiring the data through secured communication channels employing encryption and authenticated source verification, and wherein the method further comprises validating source identifiers prior to accepting the data for preprocessing to ensure integrity and trustworthiness of the received cybersecurity-related data.

In an embodiment, preprocessing the received cybersecurity-related data further comprises generating unified entity identifiers by correlating user credentials, device identifiers, network addresses, application identifiers, and access tokens across different digital sources, such that events associated with the same logical entity are processed within a common behavioral context. In an embodiment, generating the behavioral profiles comprises applying supervised learning techniques trained on previously labeled cybersecurity incidents in combination with unsupervised learning techniques trained on unlabeled operational data, such that the behavioral profiles represent both known malicious behavior patterns and statistically learned normal behavior patterns.

In an embodiment, generating the behavioral profiles further comprises adapting the behavioral profiles incrementally by incorporating newly observed operational data while retaining historical behavioral characteristics, thereby preventing abrupt changes in learned baselines due to short-term or transient behavior variations.

In an embodiment, correlating the structured event representations comprises constructing event relationship representations that capture interactions among entities, resources, and actions over time, and analyzing the event relationship representations to identify lateral movement activities, privilege escalation attempts, and coordinated sequences indicative of advanced cyber intrusion behavior.

In an embodiment, computing the dynamic risk values comprises assigning weighted significance values to event attributes including frequency of occurrence, temporal proximity between correlated events, sequence ordering, and sensitivity of affected resources, and aggregating the weighted significance values relative to the behavioral profiles to determine threat severity.

In an embodiment, initiating the cybersecurity mitigation actions comprises selectively executing actions including restricting network connectivity of affected entities, limiting access privileges, isolating computing devices, generating security notifications, or triggering remediation procedures, based on the computed dynamic risk values and predefined operational impact constraints.

In an embodiment, the method further comprises recording outcomes of the initiated cybersecurity mitigation actions and associating the outcomes with corresponding activity sequences, and wherein the outcomes are used to refine the behavioral profiles and risk computation logic during subsequent learning cycles.

In an embodiment, continuously updating the behavioral profiles further comprises evaluating detection accuracy and false alert occurrences over time and adjusting learning parameters of the artificial intelligence processing processor to maintain stability and accuracy under changing operational conditions.

In an embodiment, receiving the cybersecurity-related data streams further comprises deploying a source-specific data acquisition agent at each heterogeneous digital source, each data acquisition agent being configured to locally buffer raw event logs, packet traces, authentication records, and application telemetry, to perform initial schema tagging and cryptographic hashing on each event record, to attach source-specific metadata including collection timestamp, source type, and trust level, and to transmit the tagged event records in an encrypted batch stream to the computing system using a mutually authenticated session protocol, such that the computing system receives verifiable, source-attributed, and tamper-evident cybersecurity-related data streams prior to preprocessing.

In this embodiment, the data ingestion architecture is implemented through a distributed layer of lightweight acquisition agents that are instantiated directly at the point of generation of security telemetry, such as on firewalls, operating systems, cloud workloads, industrial controllers, and application servers. Each agent executes within the same execution environment as the data source, allowing it to intercept security-relevant artifacts before any external modification or log forwarding occurs. The agent maintains a protected local buffer implemented using a circular memory queue that temporarily stores raw event records when network connectivity is unstable or when upstream ingestion capacity is saturated, thereby preventing data loss and ensuring continuity of forensic evidence. As each event is captured, the agent applies a source-specific structural grammar that identifies the semantic meaning of individual fields and assigns a preliminary schema tag, allowing heterogeneous formats to be categorized at the point of origin. This early-stage semantic labeling ensures that downstream normalization does not rely on unreliable or incomplete raw fields, thereby increasing the accuracy of subsequent correlation and behavior modeling.

Following semantic tagging, each event record is cryptographically hashed using a chained hash structure in which the hash of a current record is derived from both the event content and the hash of the immediately preceding record in the buffer. This chaining mechanism creates an immutable sequence of records that mathematically exposes any unauthorized alteration, deletion, or reordering of telemetry at the source level. The agent further enriches each record with dynamically generated metadata that includes a high-resolution collection timestamp synchronized to a trusted reference, a logical classification of the source system, and a continuously updated trust score derived from the historical reliability and consistency of the source. This metadata allows the receiving computing platform to determine not only the origin of the data, but also its relative reliability and contextual relevance during downstream analysis.

Once a predefined batch threshold or latency window is reached, the agent transmits the tagged and hashed event records to the central computing system using a mutually authenticated communication session established through certificate-based identity verification. The encryption and authentication mechanisms ensure that only authorized endpoints can exchange data and that man-in-the-middle injection or replay attacks are cryptographically prevented. Upon reception, the computing system validates the hash chain and source identity before admitting the records into the preprocessing pipeline. The technical effect achieved by this architecture is the creation of a trusted, tamper-evident telemetry fabric in which every security event can be cryptographically traced back to its origin and verified for integrity. This eliminates ambiguity in multi-source environments, prevents the ingestion of forged or manipulated logs, and significantly enhances the reliability of behavioral analytics, correlation accuracy, and automated risk computation, thereby advancing the system beyond conventional log collection frameworks that lack source-level validation and cryptographic accountability.

In an embodiment, preprocessing the received cybersecurity-related data further comprises executing a temporal alignment process in which event timestamps originating from different digital sources are converted into a common time reference using clock drift estimation and correction, followed by transforming source-specific event fields into a normalized feature schema using rule-based field mapping tables stored in the memory units, and further performing entity disambiguation by comparing combinations of user identifiers, device fingerprints, network endpoints, and application session attributes to generate a unified entity index that is persistently stored and updated within the memory units.

In this embodiment, the preprocessing layer operates as a deterministic normalization and identity-resolution engine that transforms heterogeneous, asynchronous security telemetry into a coherent, entity-centric data representation suitable for behavioral analysis. The process begins by reconstructing a reliable global event timeline from disparate digital sources whose internal clocks may drift due to network latency, hardware variance, or misconfiguration. To achieve this, the system continuously estimates clock offset and drift for each source by statistically comparing reference synchronization markers, correlated authentication exchanges, and network handshake events that appear across multiple logs. Using these correlations, correction factors are computed and applied to each incoming timestamp so that all events are projected onto a common temporal axis. This temporal harmonization ensures that causally related activities occurring across different systems can be correctly ordered, eliminating false correlations caused by clock misalignment.

After time normalization, the system transforms heterogeneous event structures into a unified feature representation by applying rule-based field mapping tables that are stored and versioned within the memory units. These mapping tables define semantic equivalences between vendor-specific or platform-specific fields and the platform's internal feature schema, allowing, for example, a firewall session identifier, a cloud workload ID, and an application token to be interpreted as the same logical session attribute. Each incoming event is parsed according to its source tag, and the corresponding transformation rules are executed to generate a normalized feature vector. This schema harmonization process ensures that downstream analytics operate on consistent, machine-interpretable attributes regardless of the original data format, thereby eliminating dependency on source-specific log syntaxes.

The normalized events are then passed through an entity disambiguation engine that resolves whether multiple records belong to the same logical actor. This is achieved by comparing composite identity signatures formed from user credentials, device fingerprints, network endpoints, and application session characteristics. Probabilistic similarity scoring is applied to these identity signatures to determine whether new events should be associated with an existing entity or assigned to a newly created one. The resolved identities are persistently maintained within a unified entity index stored in the memory units, which is continuously updated as new evidence becomes available. The technical effect of this preprocessing architecture is the conversion of fragmented, inconsistent, and temporally unreliable telemetry into a synchronized, normalized, and entity-aligned event stream. This enables precise cross-system correlation, reduces identity ambiguity, and provides a stable foundation for behavioral profiling and real-time risk computation, representing a significant technical advancement over conventional log preprocessing systems that rely solely on static timestamps and isolated identifiers.

In an embodiment, generating the behavioral profiles further comprises segmenting the historical behavioral data by entity type and operational context, extracting multi-dimensional behavioral features including access frequency, resource usage duration, command execution sequences, communication endpoints, and privilege changes, and training a composite behavioral baseline model for each unified entity using a weighted fusion of short-term activity trends and long-term historical patterns stored in the memory units, such that deviations are computed relative to both recent and established behavior states.

In this embodiment, the behavioral modeling layer operates as a context-aware learning engine that constructs adaptive baselines for each resolved entity by structurally separating behavioral evidence according to both the role of the entity and the operational conditions under which the activity occurs. Historical event data associated with each unified entity is first partitioned into logical segments based on entity classification, such as human user, service account, virtual machine, application workload, or network device, and is further subdivided according to contextual states such as working hours, maintenance windows, geographic zones, or production versus testing environments. This segmentation ensures that behavior is evaluated relative to the appropriate operational scenario rather than against a single static baseline, thereby preventing legitimate contextual changes from being misclassified as anomalous.

From each segmented behavioral dataset, the system derives a multi-dimensional feature representation that quantitatively captures how the entity interacts with digital assets and services over time. These features include statistically modeled access frequencies, session and resource utilization durations, ordered command and API invocation sequences encoded as transition vectors, communication peer distributions, and privilege escalation or de-escalation patterns. The extracted features are stored in the memory units and continuously updated as new activity is observed. The system then constructs a composite baseline model for each entity by applying a weighted fusion strategy that combines short-term activity profiles, which reflect the entity's current operating behavior, with long-term historical models that represent stable identity characteristics. The weighting coefficients are dynamically adjusted to reflect the reliability and relevance of recent data while still preserving long-term behavioral constraints.

When new activity is observed, the system computes deviations by comparing the incoming feature vectors against both the short-term and long-term components of the composite baseline. This dual-reference evaluation allows the system to distinguish between transient operational shifts and structurally abnormal behavior. The technical effect achieved is the creation of an adaptive, self-calibrating behavioral model that evolves with legitimate changes while remaining sensitive to coordinated or stealthy intrusions. This represents a significant technical advancement over static or single-window behavioral baselines, enabling higher detection accuracy, reduced false positives, and real-time responsiveness in complex, dynamic computing environments.

In an embodiment, correlating the structured event representations further comprises organizing events associated with each unified entity into ordered activity chains based on temporal proximity and shared resource references, linking the activity chains across different digital sources using common entity identifiers and session continuity indicators, generating multi-stage activity graphs that capture cross-system propagation behavior, and storing the multi-stage activity graphs within the memory units for real-time traversal during risk evaluation.

In this embodiment, the correlation layer transforms normalized, entity-aligned events into structured behavioral pathways that reveal how actions propagate across multiple systems and security domains. The process begins by grouping all events associated with a given unified entity into temporally ordered sequences, where events occurring within dynamically computed time windows are clustered together based on proximity and on references to shared digital resources such as files, credentials, network ports, or application objects. These clusters are then assembled into ordered activity chains that represent discrete behavioral phases, for example authentication, privilege change, resource access, and lateral communication. This ordered structuring ensures that individual actions are no longer treated as isolated signals but as components of a larger operational sequence.

Once entity-level chains are formed, the system establishes cross-source continuity by linking chains that originate from different digital platforms using persistent entity identifiers, session correlation markers, and resource interaction fingerprints. For instance, a session token observed in a cloud application log may be associated with a network flow record and a host-based command execution trace, allowing the system to infer a single continuous behavioral path across environments. These linked chains are then abstracted into multi-stage activity graphs in which nodes represent behavioral states or resource interactions and edges represent transitions between states across systems. The graphs are persistently stored within the memory units and indexed for real-time traversal.

During risk evaluation, the artificial intelligence processing engine traverses these graphs to identify abnormal propagation paths, cyclical behaviors, or unexpected cross-domain transitions that are indicative of coordinated intrusion activity. The technical effect achieved is the conversion of fragmented security telemetry into a unified, graph-based representation of cross-system behavior, enabling the system to detect complex, multi-stage attacks that would remain invisible to rule-based or single-log correlation systems. This graph-centric correlation framework constitutes a significant technical advancement by providing contextual continuity, causal traceability, and real-time analytical depth across heterogeneous digital infrastructures.

In an embodiment, computing the dynamic risk values further comprises generating a contextual risk vector for each identified activity sequence by quantifying deviations from the behavioral profiles across multiple behavioral dimensions, scaling each deviation according to asset sensitivity scores and operational criticality metrics stored in the memory units, aggregating the scaled deviations using adaptive weighting coefficients that are updated based on historical detection outcomes, and outputting a composite risk score that is compared against entity-specific and environment-specific threshold values.

In this embodiment, the risk evaluation engine operates as a context-aware scoring mechanism that transforms behavioral deviations into a normalized, decision-ready risk metric. For each correlated activity sequence, the system first derives a contextual risk vector by measuring how far the observed behavioral features diverge from the composite behavioral baselines associated with the corresponding unified entity. These deviations are computed across multiple behavioral dimensions, including frequency of access, command sequence entropy, privilege transitions, communication scope, and resource utilization patterns. Each deviation is expressed as a normalized distance value relative to the acceptable behavioral envelopes stored in memory, thereby ensuring that different feature scales are directly comparable.

The system then applies a sensitivity-aware scaling stage in which each deviation component is multiplied by asset sensitivity scores and operational criticality metrics retrieved from the memory units. For example, anomalous behavior affecting a financial database or control system is amplified relative to similar behavior on a low-impact test server. The scaled deviations are aggregated into a single composite score using adaptive weighting coefficients that reflect the historical effectiveness of each behavioral dimension in detecting true threats. These coefficients are continuously recalibrated based on past detection outcomes, including confirmed intrusions and false alerts, allowing the scoring model to learn which signals are most predictive in a given environment.

Finally, the composite risk score is compared against threshold values that are dynamically defined per entity class and per operational environment, such as production, development, or restricted network zones. This contextual thresholding ensures that identical behaviors are not uniformly classified across dissimilar contexts. The technical effect achieved is a self-adjusting, risk-aware decision framework that produces consistent and explainable risk scores across heterogeneous infrastructures. This represents a significant technical advancement over static scoring models by introducing adaptive weighting, asset-aware scaling, and context-sensitive thresholding into real-time cybersecurity risk computation.

In an embodiment, initiating the cybersecurity mitigation actions further comprises selecting one or more mitigation workflows from a predefined response policy library stored in the memory units, dynamically parameterizing each selected mitigation workflow using attributes of the correlated activity sequence and the affected digital assets, transmitting enforcement commands through the communication interface unit to network controllers, identity access systems, and endpoint protection agents, and recording execution status, response latency, and post-action system state for association with the originating activity sequence.

In this embodiment, the mitigation orchestration layer functions as an automated, closed-loop enforcement engine that converts computed risk outcomes into context-aware security responses across the digital infrastructure. When an activity sequence exceeds its corresponding risk threshold, the system queries a policy library stored in the memory units to identify response workflows that are compatible with the entity type, the class of detected behavior, and the sensitivity of the impacted assets. Each workflow defines a structured sequence of control actions, such as network segmentation, credential restriction, session termination, or application throttling, along with prerequisite conditions and rollback constraints. The selected workflow is then dynamically parameterized by injecting real-time attributes extracted from the correlated activity graph, including entity identifiers, accessed resources, privilege level, propagation path, and current operational state of the target systems.

Once parameterized, the workflow is executed by transmitting enforcement instructions through the communication interface unit to the appropriate control planes, such as software-defined network controllers, identity and access management platforms, and endpoint protection agents. Each instruction is authenticated and verified before execution, ensuring that only authorized mitigation actions are applied. As the actions are carried out, the system continuously monitors their execution state, capturing timestamps, response latency, success or failure codes, and changes in system behavior following enforcement. These execution artifacts are persistently associated with the originating activity sequence and stored for audit, feedback, and model retraining purposes.

The technical effect achieved by this architecture is the transformation of threat detection into an autonomous response capability that operates at machine speed while remaining context-sensitive and reversible. By dynamically binding mitigation logic to real-time behavioral evidence and continuously measuring post-action impact, the system advances beyond static incident response frameworks and enables adaptive, verifiable, and self-improving cybersecurity defense.

In an embodiment, continuously updating the behavioral profiles further comprises assigning confidence weights to detection outcomes based on whether initiated mitigation actions were confirmed as valid threats or false alerts, adjusting learning rates and feature importance values for each behavioral profile according to the assigned confidence weights, storing versioned profile states within the memory units, and deploying the updated profile states for use in subsequent correlation and risk computation cycles without interrupting real-time data ingestion.

In this embodiment, the learning and adaptation layer operates as a closed-loop optimization engine that continuously refines the behavioral models based on real-world response outcomes. After a mitigation action is executed, the system evaluates whether the triggering activity sequence corresponded to a verified threat or a false alert by analyzing post-action indicators, operator feedback signals, and downstream system stability metrics. A confidence weight is then assigned to the detection outcome, where higher weights are given to sequences that were confirmed as malicious and lower or negative weights are applied to sequences determined to be benign. These confidence values are propagated back to the learning engine to control how strongly each outcome influences future model updates.

Using the assigned confidence weights, the system dynamically adjusts learning rates and feature importance values within each behavioral profile. Behavioral dimensions that consistently contribute to accurate detections are amplified, while those associated with false alerts are attenuated. The model parameters are updated incrementally to avoid disruptive retraining cycles, and each updated profile is stored as a new versioned state within the memory units, preserving historical models for audit and rollback purposes. The most recent validated profile versions are then deployed into the live correlation and risk evaluation pipeline through a non-blocking update mechanism, ensuring that real-time data ingestion and analysis are not interrupted during model refresh.

The technical effect achieved is a self-correcting behavioral intelligence framework that continuously improves detection accuracy based on operational feedback. By integrating outcome-aware weighting, adaptive learning control, and versioned deployment, the system advances beyond static or periodically retrained models and enables persistent, real-time optimization of cybersecurity behavior analytics.

In an embodiment, storing the structured event representations and historical behavioral data further comprises organizing the data within a distributed in-memory data fabric that partitions records by unified entity identifier and time window, replicates high-risk entity data across multiple memory nodes for fault tolerance, applies write-ahead logging for each update, and supports real-time indexed retrieval by the artificial intelligence processing processor during behavioral profile generation and correlation processing.

In this embodiment, the data persistence layer is implemented as a distributed in-memory data fabric that provides high-throughput, low-latency access to structured event records and historical behavioral features while preserving consistency and fault tolerance. The fabric logically partitions incoming records using a composite key formed from the unified entity identifier and a sliding temporal window, ensuring that all activity associated with a given entity and time period is co-located within the same memory shard. This partitioning strategy allows the behavioral modeling and correlation engines to retrieve complete entity timelines with constant-time access, even under large-scale data volumes.

To ensure resilience, records associated with high-risk or mission-critical entities are automatically replicated across multiple memory nodes based on their dynamically computed risk tiers. If a node becomes unavailable, the replicated partitions allow uninterrupted access to behavioral histories without data loss. Each write operation is protected by a write-ahead logging mechanism that records state changes to persistent storage before they are committed to memory, enabling rapid recovery and rollback in the event of system failure.

The fabric further maintains real-time indexing structures on entity identifiers, temporal ranges, and behavioral feature dimensions, allowing the artificial intelligence processing processor to perform immediate lookups during behavioral profile generation and cross-entity correlation. The technical effect achieved is a memory architecture that supports continuous, real-time analytics at scale while maintaining consistency, availability, and fault tolerance. This represents a significant technical advancement over disk-based log stores and batch analytics systems by enabling deterministic, low-latency behavioral intelligence across distributed cybersecurity environments.

In an embodiment, generating the behavioral profiles further comprises computing baseline activity envelopes for each unified entity by calculating acceptable behavioral ranges for access frequency, session duration, command diversity, communication peer counts, and privilege usage ratios, storing the baseline activity envelopes within the memory units, and continuously recalibrating the baseline activity envelopes using decay functions that reduce the influence of obsolete historical data while preserving long-term behavioral constraints.

In this embodiment, the behavioral modeling engine derives a dynamic boundary model for each unified entity by statistically characterizing what constitutes acceptable operational behavior over time. For every entity, the system computes baseline activity envelopes by analyzing historical distributions of access frequency, session duration, command and API invocation diversity, communication peer counts, and privilege usage ratios. These distributions are converted into bounded ranges using adaptive statistical thresholds, such as percentile bands and variance-adjusted limits, which define the normal operating envelope for each behavioral dimension. The envelopes are persistently stored in the memory units and indexed to the corresponding entity profiles so that they can be efficiently retrieved during real-time evaluation.

As new behavioral data is ingested, the system continuously recalibrates these envelopes through decay-based update functions that progressively reduce the influence of obsolete or rarely repeated historical behavior while retaining constraints derived from long-term patterns. For example, older activity distributions are down-weighted using exponential decay, whereas consistent long-term traits maintain higher persistence weights. This approach allows the envelopes to evolve in response to legitimate operational changes, such as role transitions or system upgrades, without losing the ability to detect subtle deviations that may indicate compromise.

In an embodiment, correlating the structured event representations further comprises applying a causal sequencing mechanism that evaluates directional dependencies between temporally adjacent events by measuring state transitions of affected digital assets, identifying trigger- response relationships between events across different digital sources, and constructing causal dependency chains that are stored and traversed to distinguish coincidental activity from coordinated multi-stage cyber intrusion behavior.

In this embodiment, the behavioral modeling engine derives a dynamic boundary model for each unified entity by statistically characterizing what constitutes acceptable operational behavior over time. For every entity, the system computes baseline activity envelopes by analyzing historical distributions of access frequency, session duration, command and API invocation diversity, communication peer counts, and privilege usage ratios. These distributions are converted into bounded ranges using adaptive statistical thresholds, such as percentile bands and variance-adjusted limits, which define the normal operating envelope for each behavioral dimension. The envelopes are persistently stored in the memory units and indexed to the corresponding entity profiles so that they can be efficiently retrieved during real-time evaluation.

As new behavioral data is ingested, the system continuously recalibrates these envelopes through decay-based update functions that progressively reduce the influence of obsolete or rarely repeated historical behavior while retaining constraints derived from long-term patterns. For example, older activity distributions are down-weighted using exponential decay, whereas consistent long-term traits maintain higher persistence weights. This approach allows the envelopes to evolve in response to legitimate operational changes, such as role transitions or system upgrades, without losing the ability to detect subtle deviations that may indicate compromise.

In an embodiment, computing the dynamic risk values further comprises generating a confidence score for each identified activity sequence by comparing similarity of the activity sequence to stored historical attack patterns and benign operational patterns, adjusting the confidence score based on contextual constraints including time-of-day, geographic origin, device trust level, and access policy compliance state, and incorporating the confidence score into the dynamic risk value calculation prior to threshold evaluation.

In this embodiment, the correlation layer incorporates a causal sequencing engine that infers directional relationships between events rather than relying solely on temporal proximity. For each temporally adjacent event pair associated with a unified entity or shared digital asset, the system evaluates whether the first event induces a measurable state transition in the affected resource, such as a change in access permissions, process execution state, network connection status, file integrity, or authentication context. These state transitions are extracted from system telemetry and represented as before-and-after state vectors, which are compared to determine whether the earlier event plausibly caused the later event.

The engine then analyzes cross-source interactions by linking state transitions observed in different digital platforms, such as correlating a privilege escalation on a server with a subsequent abnormal database query or outbound network connection. Trigger-response patterns are identified using conditional dependency scoring, which quantifies how consistently a given event type precedes another within a constrained time window and asset scope. Events that satisfy both temporal ordering and state-transition dependency criteria are connected into causal dependency chains.

These chains are persistently stored and indexed for traversal during risk evaluation. When analyzing new activity, the system traverses existing chains to determine whether observed sequences match known coordinated propagation patterns or represent isolated, coincidental actions. The technical effect achieved is the ability to distinguish true multi-stage intrusion behavior from random or independent events, enabling accurate detection of coordinated cyber attacks. This causal correlation mechanism represents a significant technical advancement over rule-based or time-only correlation systems by embedding directional logic and asset state awareness into real-time cybersecurity analytics.

In an embodiment, initiating the cybersecurity mitigation actions further comprises executing staged enforcement by first applying reversible containment actions to affected entities, monitoring post-containment activity changes over a predefined observation interval, escalating to restrictive isolation or credential suspension actions when anomalous behavior persists beyond the observation interval, and recording each enforcement stage and corresponding system response state for association with the originating activity sequence.

In this embodiment, the response orchestration layer implements a progressive enforcement strategy that minimizes operational disruption while ensuring that persistent threats are decisively neutralized. When an activity sequence is classified as high risk, the system initially applies reversible containment measures that temporarily restrict the affected entity's interaction scope, such as throttling network bandwidth, limiting access to sensitive resources, or forcing re-authentication. These actions are executed through the communication interface and are designed to constrain potentially malicious behavior without permanently altering system state, allowing legitimate operations to recover if the detection is later determined to be benign.

Following containment, the system enters an observation phase during which it continuously monitors post-enforcement telemetry to assess whether the anomalous behavioral patterns subside or continue. This monitoring interval is dynamically determined based on asset criticality and risk level. If the behavior returns to within the established baseline envelopes, the containment actions are automatically rolled back. However, if anomalous activity persists or escalates, the system transitions to a restrictive enforcement stage by invoking stronger controls, such as isolating the entity from the network, suspending credentials, or terminating sessions across connected systems.

Each enforcement stage, along with system response metrics such as latency, behavioral changes, and asset state transitions, is persistently recorded and linked to the originating activity sequence. The technical effect achieved is a closed-loop, adaptive response framework that applies proportionate controls based on real-time feedback rather than static rules. This represents a significant technical advancement over conventional incident response systems by enabling automated, staged mitigation that balances security assurance with operational continuity.

In an embodiment, continuously updating the behavioral profiles further comprises performing drift detection by comparing current behavioral feature distributions against historical baseline distributions using divergence metrics, identifying statistically significant shifts in operational behavior, selectively retraining only affected portions of the behavioral profiles based on the detected drift, and preserving unaffected profile components to maintain continuity across learning cycles, and wherein generating the behavioral profiles further comprises constructing hierarchical behavior models in which individual entity profiles are aggregated into group-level profiles for departments, network zones, application clusters, and trust domains, storing the hierarchical relationships within the memory units, and computing deviation measures at both the individual and group levels during dynamic risk evaluation.

In this embodiment, the learning engine incorporates a drift-aware adaptation mechanism that continuously monitors whether the operational behavior of entities is evolving beyond the limits captured in the existing behavioral models. For each unified entity, the system periodically compares the statistical distributions of newly observed behavioral features against the corresponding historical baseline distributions using divergence metrics that quantify how much the two distributions differ over time. When the measured divergence exceeds an adaptive significance threshold, the system determines that a meaningful behavioral drift has occurred rather than a transient fluctuation. Instead of retraining the entire model, the system isolates only those feature dimensions and behavioral components that exhibit statistically significant change and selectively retrains those portions, while preserving all other stable components of the profile. This targeted retraining approach maintains continuity across learning cycles, reduces computational overhead, and prevents unnecessary erosion of long-term behavioral knowledge.

In parallel, the behavioral modeling layer constructs hierarchical behavior representations by aggregating individual entity profiles into higher-order group profiles that correspond to organizational or infrastructural structures, such as departments, network segments, application clusters, and trust domains. The hierarchical relationships between individual and group profiles are persistently stored within the memory units and dynamically updated as entities move between operational contexts. During risk evaluation, the system computes deviation measures at both the individual level and the group level, enabling it to detect not only isolated anomalies but also coordinated deviations that affect entire organizational units or infrastructure segments.

In an embodiment, receiving the cybersecurity-related data streams further comprises dynamically classifying each heterogeneous digital source into trust tiers based on historical reliability, data completeness, and anomaly contribution rates, assigning tier-specific validation rules and ingestion priorities to incoming event records, and routing the event records through tier-specific preprocessing pipelines stored in the memory units before correlation and behavioral analysis, and wherein preprocessing the received cybersecurity-related data further comprises performing semantic enrichment by associating each structured event representation with asset classification tags, role-based access attributes, and operational context labels retrieved from enterprise configuration repositories, and appending the semantic enrichment metadata to the structured event representations for use during correlation and risk computation.

In this embodiment, the ingestion layer incorporates an adaptive trust management mechanism that continuously evaluates the reliability of each digital source by analyzing historical telemetry consistency, data completeness ratios, transmission error rates, and the statistical contribution of that source to confirmed detections or false alerts. Using these performance indicators, the system dynamically assigns each source to a trust tier that reflects its evidentiary reliability. For every tier, the memory units store a dedicated set of validation constraints, prioritization rules, and preprocessing workflows. As event records arrive, the system applies tier-specific integrity checks, confidence weighting, and queuing priorities, and routes the data through the corresponding preprocessing pipeline. High-trust sources are fast-tracked with minimal validation overhead, while lower-trust sources are subjected to stricter verification, redundancy checks, and delayed correlation. This tier-aware routing ensures that unreliable telemetry cannot disproportionately influence behavioral analytics while still preserving visibility across all sources.

Following trust-tier processing, the preprocessing engine performs semantic enrichment to contextualize each structured event with enterprise knowledge. The system queries configuration repositories, asset inventories, identity governance platforms, and network topology maps to retrieve asset classification tags, role-based access attributes, and operational context indicators corresponding to the entities and resources referenced in each event. This metadata is appended to the structured event representations and indexed within the memory units. During correlation and risk evaluation, the enriched attributes allow the system to interpret identical technical actions differently depending on asset sensitivity, user role, and operational state. The technical effect achieved is the transformation of raw telemetry into context-aware, reliability-weighted behavioral evidence. This represents a significant technical advancement over conventional log ingestion systems by enabling trust-adaptive processing and semantically enriched analytics that dramatically improve accuracy, prioritization, and real-time threat discernment.

In operation, the system first performs continuous acquisition of cybersecurity-related data from a plurality of heterogeneous digital sources through secured communication interfaces. These sources include network communication interfaces generating traffic metadata, computing devices producing operating system and process-level events, application execution environments generating runtime logs, identity management services producing authentication and authorization records, and data storage systems generating access and modification events. Each incoming data stream is received with associated source identifiers and timestamps and is validated to ensure integrity and authenticity prior to further processing. This ensures that the subsequent analytical stages operate on trusted telemetry and reduces the risk of adversarial data poisoning.

Once received, the data is forwarded to the preprocessing processor, which executes a normalization technique that aligns the disparate data streams into a unified event representation. The technique synchronizes timestamps using a common time reference, resolves inconsistencies in data formats, and maps source-specific identifiers into standardized entity attributes. During this stage, redundant records, non-informative status messages, and incomplete entries are filtered to reduce noise. The preprocessing processor further correlates user credentials, device identifiers, network addresses, application identifiers, and access tokens to generate unified entity identifiers, thereby ensuring that activities originating from the same logical entity are associated with a consistent behavioral context across different data sources.

The structured event representations produced by preprocessing are stored in the memory units along with historical behavioral data associated with each unified entity identifier. The artificial intelligence processing processor accesses this stored data to construct behavioral profiles for users, devices, applications, and network segments. The technique for behavioral profiling operates by first establishing baseline behavior patterns using historical operational data, capturing attributes such as typical access times, frequency of actions, resource usage distributions, communication patterns, and execution sequences. These baseline patterns are learned through a combination of supervised learning, where previously labeled threat instances guide the identification of malicious patterns, and unsupervised learning, where statistical regularities in unlabeled data are used to model normal behavior without prior assumptions.

As new structured event representations are generated, the artificial intelligence processing processor evaluates them against the learned behavioral profiles. The technique computes deviation measures that quantify the extent to which observed behavior diverges from established baselines. These deviation measures are not limited to single events but are aggregated across temporal windows to capture evolving behavior trends. To prevent instability due to transient or legitimate behavior changes, the technique incorporates incremental learning mechanisms that update behavioral profiles gradually, preserving historical context while adapting to long-term operational shifts.

In parallel, the correlation processor executes an event correlation technique that analyzes temporal ordering, contextual associations, and relational dependencies among structured event representations originating from different data sources. The technique constructs event relationship representations that capture interactions between entities, resources, and actions over time. By traversing these representations, the correlation processor identifies multi-stage activity sequences indicative of lateral movement, privilege escalation, persistence establishment, or coordinated attack campaigns. This cross-domain correlation enables detection of complex intrusion patterns that would not be apparent from isolated events.

The risk assessment processor receives correlated activity sequences and associated deviation measures from the artificial intelligence processing processor. The risk computation technique assigns weighted significance values to attributes such as frequency of occurrence, temporal proximity between events, sequence ordering consistency, and sensitivity of affected digital assets. These weighted values are aggregated to compute a dynamic risk value for each identified activity sequence. The risk values are continuously recalculated as additional events are observed, allowing the system to refine threat assessments in real time and to distinguish between benign anomalies and high-confidence malicious behavior.

When the computed dynamic risk value for an activity sequence satisfies a predefined or adaptively learned threshold, the response control processor executes a response selection technique to determine appropriate cybersecurity mitigation actions. The technique evaluates the risk value in conjunction with operational impact constraints to select actions such as restricting network connectivity, limiting access privileges, isolating computing devices, or generating security notifications. These actions are executed in a controlled manner to minimize disruption to legitimate operations while containing potential threats.

Following execution of mitigation actions, the system records response outcomes, including effectiveness of the actions and any subsequent changes in observed behavior. This feedback is supplied to the artificial intelligence processing processor, which incorporates the outcome data into subsequent learning cycles. By associating outcomes with corresponding activity sequences, the technique refines behavioral profiles and risk computation parameters, thereby improving detection accuracy and response precision over time.

Additionally, the system generates explanatory information associated with identified threats by tracing correlated events, detected behavioral deviations, and contributing risk factors. This explanatory information is stored within the memory units and made available for forensic analysis and compliance reporting. The generation of such explanations enhances transparency and enables security operators to understand the basis of automated decisions without compromising the autonomous operation of the system.

Through the coordinated execution of these technique steps across dedicated processors and memory units, the invention achieves an integrated and adaptive cybersecurity analysis capability. The described technique provides a technical solution that improves threat detection accuracy, reduces false alerts, enables proactive mitigation, and continuously adapts to evolving cyber threats and operational environments.

In accordance with one embodiment of the invention, the system comprises a centralized cybersecurity analysis apparatus deployed as a dedicated computing machine or distributed across multiple interconnected machines. The apparatus includes one or more input communication interfaces configured to receive cybersecurity data from a plurality of monitored sources. Such sources include network traffic sensors, endpoint operating systems, application logs, authentication services, database access logs, and cloud infrastructure telemetry.

The received data is stored within a secure memory subsystem comprising volatile and non-volatile memory units. A data normalization processor is configured to preprocess the incoming data by standardizing formats, synchronizing timestamps, resolving entity identifiers, and filtering redundant or irrelevant information. This preprocessing ensures consistent representation of data prior to analysis and reduces computational overhead.

An artificial intelligence processing unit, implemented using one or more high-performance processors or accelerators, is operatively coupled to the memory subsystem. The artificial intelligence processing unit is configured to construct behavioral models representing normal operational patterns of monitored entities. These behavioral models are generated using supervised, unsupervised, and semi-supervised learning techniques applied to historical and real-time data.

The system further includes a correlation processor configured to analyze relationships among events across multiple data sources. The correlation processor identifies temporal, spatial, and logical linkages between events to detect coordinated attack behaviors, lateral movement attempts, and multi-stage intrusion sequences. The artificial intelligence processing unit continuously evaluates correlated events against learned behavioral baselines to compute threat likelihood values.

A risk assessment processor is configured to assign dynamic risk scores to detected anomalies based on severity, confidence level, affected assets, and contextual intelligence. The risk scores are updated in real time as additional data becomes available, enabling adaptive threat prioritization. The system further includes a response control processor configured to initiate one or more mitigation actions when predefined or learned risk thresholds are exceeded. Such actions include isolating affected devices, restricting network access, revoking credentials, triggering alerts, or initiating automated remediation workflows.

The system incorporates a continuous learning mechanism whereby feedback from confirmed incidents, analyst interventions, and remediation outcomes is fed back into the artificial intelligence processing unit. This feedback enables periodic retraining and refinement of the behavioral models, thereby improving detection accuracy over time and adapting to evolving threat landscapes.

In a specific embodiment, the invention provides a cybersecurity analysis device configured as a standalone or rack-mounted machine structure. The device comprises a housing enclosing one or more multi-core processors, dedicated artificial intelligence accelerators, system memory modules, persistent storage devices, and high-speed network interface controllers. The device further includes a secure hardware root of trust for protecting cryptographic keys and ensuring integrity of system firmware and software components.

The internal architecture of the device is arranged such that data acquisition, artificial intelligence processing, correlation analysis, and response execution are performed in a pipelined manner, thereby enabling real-time threat analysis at scale. The machine structure is further configured with redundant power supplies and fault-tolerant components to ensure continuous operation in critical environments.

The device is operatively connectable to enterprise networks, cloud platforms, and remote sensors through encrypted communication channels. The physical implementation of the device ensures that cybersecurity analysis is performed as a technical process executed by hardware-supported computing resources, rather than as an abstract or purely logical operation.

In accordance with another embodiment, the invention provides a method for intelligent cybersecurity analysis using artificial intelligence. The method includes receiving cybersecurity data from multiple heterogeneous sources and preprocessing the data to generate normalized event representations. The method further includes constructing behavioral models of monitored entities using artificial intelligence techniques and continuously updating the models based on observed system behavior.

The method further involves correlating events across data sources to identify complex attack patterns and computing dynamic risk scores for detected anomalies. Upon determining that a risk score exceeds a threshold, the method initiates automated or semi-automated response actions to mitigate the identified threat. The method further includes incorporating feedback from response outcomes to refine artificial intelligence models and improve future threat detection performance.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for intelligent cybersecurity analysis using artificial intelligence, the method being executed by a computing system comprising one or more processors and memory units;
receiving cybersecurity-related data streams from a plurality of heterogeneous digital sources including network communication interfaces, computing devices, application execution environments, identity management services, and data storage systems;
preprocessing the received cybersecurity-related data by performing time synchronization, format normalization, entity resolution, and elimination of redundant or non-informative records to generate structured event representations;
storing the structured event representations and historical behavioral data associated with monitored entities within the memory units;
generating, by an artificial intelligence processing processor, behavioral profiles corresponding to users, devices, applications, and network segments by learning normal operational patterns from the historical behavioral data;
correlating the structured event representations across the plurality of digital sources by analyzing temporal ordering, contextual association, and relational dependencies to identify multi-stage and cross-domain activity sequences; computing dynamic risk values for the identified activity sequences based on deviation from the behavioral profiles, contextual relevance of the activity sequences, and criticality of affected digital assets; and
initiating one or more cybersecurity mitigation actions when the computed dynamic risk values satisfy predefined or adaptively learned thresholds; and continuously updating the behavioral profiles based on newly observed data and outcomes of the mitigation actions to improve subsequent threat detection accuracy, wherein receiving the cybersecurity-related data streams comprises acquiring the data through secured communication channels employing encryption and authenticated source verification, and wherein the method further comprises validating source identifiers prior to accepting the data for preprocessing to ensure integrity and trustworthiness of the received cybersecurity-related data, and wherein preprocessing the received cybersecurity-related data further comprises generating unified entity identifiers by correlating user credentials, device identifiers, network addresses, application identifiers, and access tokens across different digital sources, such that events associated with the same logical entity are processed within a common behavioral context.

2. The method of claim 1, wherein generating the behavioral profiles comprises applying supervised learning techniques trained on previously labeled cybersecurity incidents in combination with unsupervised learning techniques trained on unlabeled operational data, such that the behavioral profiles represent both known malicious behavior patterns and statistically learned normal behavior patterns, and wherein generating the behavioral profiles further comprises adapting the behavioral profiles incrementally by incorporating newly observed operational data while retaining historical behavioral characteristics, thereby preventing abrupt changes in learned baselines due to short-term or transient behavior variations.

3. The method of claim 1, wherein correlating the structured event representations comprises constructing event relationship representations that capture interactions among entities, resources, and actions over time, and analyzing the event relationship representations to identify lateral movement activities, privilege escalation attempts, and coordinated sequences indicative of advanced cyber intrusion behavior, and wherein computing the dynamic risk values comprises assigning weighted significance values to event attributes including frequency of occurrence, temporal proximity between correlated events, sequence ordering, and sensitivity of affected resources, and aggregating the weighted significance values relative to the behavioral profiles to determine threat severity.

4. The method of claim 1, wherein initiating the cybersecurity mitigation actions comprises selectively executing actions including restricting network connectivity of affected entities, limiting access privileges, isolating computing devices, generating security notifications, or triggering remediation procedures, based on the computed dynamic risk values and predefined operational impact constraints, and wherein the method further comprises recording outcomes of the initiated cybersecurity mitigation actions and associating the outcomes with corresponding activity sequences, and wherein the outcomes are used to refine the behavioral profiles and risk computation logic during subsequent learning cycles.

5. The method of claim 1, wherein continuously updating the behavioral profiles further comprises evaluating detection accuracy and false alert occurrences over time and adjusting learning parameters of the artificial intelligence processing processor to maintain stability and accuracy under changing operational conditions.

6. The method of claim 1, wherein receiving the cybersecurity-related data streams further comprises deploying a source-specific data acquisition agent at each heterogeneous digital source, each data acquisition agent being configured to locally buffer raw event logs, packet traces, authentication records, and application telemetry, to perform initial schema tagging and cryptographic hashing on each event record, to attach source-specific metadata including collection timestamp, source type, and trust level, and to transmit the tagged event records in an encrypted batch stream to the computing system using a mutually authenticated session protocol, such that the computing system receives verifiable, source-attributed, and tamper-evident cybersecurity-related data streams prior to preprocessing.

7. The method of claim 1, wherein preprocessing the received cybersecurity-related data further comprises executing a temporal alignment process in which event timestamps originating from different digital sources are converted into a common time reference using clock drift estimation and correction, followed by transforming source-specific event fields into a normalized feature schema using rule-based field mapping tables stored in the memory units, and further performing entity disambiguation by comparing combinations of user identifiers, device fingerprints, network endpoints, and application session attributes to generate a unified entity index that is persistently stored and updated within the memory units.

8. The method of claim 1, wherein generating the behavioral profiles further comprises segmenting the historical behavioral data by entity type and operational context, extracting multi-dimensional behavioral features including access frequency, resource usage duration, command execution sequences, communication endpoints, and privilege changes, and training a composite behavioral baseline model for each unified entity using a weighted fusion of short-term activity trends and long-term historical patterns stored in the memory units, such that deviations are computed relative to both recent and established behavior states.

9. The method of claim 1, wherein correlating the structured event representations further comprises organizing events associated with each unified entity into ordered activity chains based on temporal proximity and shared resource references, linking the activity chains across different digital sources using common entity identifiers and session continuity indicators, generating multi-stage activity graphs that capture cross-system propagation behavior, and storing the multi-stage activity graphs within the memory units for real-time traversal during risk evaluation.

10. The method of claim 1, wherein computing the dynamic risk values further comprises generating a contextual risk vector for each identified activity sequence by quantifying deviations from the behavioral profiles across multiple behavioral dimensions, scaling each deviation according to asset sensitivity scores and operational criticality metrics stored in the memory units, aggregating the scaled deviations using adaptive weighting coefficients that are updated based on historical detection outcomes, and outputting a composite risk score that is compared against entity-specific and environment-specific threshold values.

11. The method of claim 1, wherein initiating the cybersecurity mitigation actions further comprises selecting one or more mitigation workflows from a predefined response policy library stored in the memory units, dynamically parameterizing each selected mitigation workflow using attributes of the correlated activity sequence and the affected digital assets, transmitting enforcement commands through the communication interface unit to network controllers, identity access systems, and endpoint protection agents, and recording execution status, response latency, and post-action system state for association with the originating activity sequence.

12. The method of claim 1, wherein continuously updating the behavioral profiles further comprises assigning confidence weights to detection outcomes based on whether initiated mitigation actions were confirmed as valid threats or false alerts, adjusting learning rates and feature importance values for each behavioral profile according to the assigned confidence weights, storing versioned profile states within the memory units, and deploying the updated profile states for use in subsequent correlation and risk computation cycles without interrupting real-time data ingestion.

13. The method of claim 1, wherein storing the structured event representations and historical behavioral data further comprises organizing the data within a distributed in-memory data fabric that partitions records by unified entity identifier and time window, replicates high-risk entity data across multiple memory nodes for fault tolerance, applies write-ahead logging for each update, and supports real-time indexed retrieval by the artificial intelligence processing processor during behavioral profile generation and correlation processing.

14. The method of claim 1, wherein generating the behavioral profiles further comprises computing baseline activity envelopes for each unified entity by calculating acceptable behavioral ranges for access frequency, session duration, command diversity, communication peer counts, and privilege usage ratios, storing the baseline activity envelopes within the memory units, and continuously recalibrating the baseline activity envelopes using decay functions that reduce the influence of obsolete historical data while preserving long-term behavioral constraints.

15. The method of claim 1, wherein correlating the structured event representations further comprises applying a causal sequencing mechanism that evaluates directional dependencies between temporally adjacent events by measuring state transitions of affected digital assets, identifying trigger-response relationships between events across different digital sources, and constructing causal dependency chains that are stored and traversed to distinguish coincidental activity from coordinated multi-stage cyber intrusion behavior.

16. The method of claim 1, wherein computing the dynamic risk values further comprises generating a confidence score for each identified activity sequence by comparing similarity of the activity sequence to stored historical attack patterns and benign operational patterns, adjusting the confidence score based on contextual constraints including time-of-day, geographic origin, device trust level, and access policy compliance state, and incorporating the confidence score into the dynamic risk value calculation prior to threshold evaluation.

17. The method of claim 1, wherein initiating the cybersecurity mitigation actions further comprises executing staged enforcement by first applying reversible containment actions to affected entities, monitoring post-containment activity changes over a predefined observation interval, escalating to restrictive isolation or credential suspension actions when anomalous behavior persists beyond the observation interval, and recording each enforcement stage and corresponding system response state for association with the originating activity sequence.

18. The method of claim 1, wherein continuously updating the behavioral profiles further comprises performing drift detection by comparing current behavioral feature distributions against historical baseline distributions using divergence metrics, identifying statistically significant shifts in operational behavior, selectively retraining only affected portions of the behavioral profiles based on the detected drift, and preserving unaffected profile components to maintain continuity across learning cycles, and wherein generating the behavioral profiles further comprises constructing hierarchical behavior models in which individual entity profiles are aggregated into group-level profiles for departments, network zones, application clusters, and trust domains, storing the hierarchical relationships within the memory units, and computing deviation measures at both the individual and group levels during dynamic risk evaluation.

19. The method of claim 1, wherein receiving the cybersecurity-related data streams further comprises dynamically classifying each heterogeneous digital source into trust tiers based on historical reliability, data completeness, and anomaly contribution rates, assigning tier-specific validation rules and ingestion priorities to incoming event records, and routing the event records through tier-specific preprocessing pipelines stored in the memory units before correlation and behavioral analysis, and wherein preprocessing the received cybersecurity-related data further comprises performing semantic enrichment by associating each structured event representation with asset classification tags, role-based access attributes, and operational context labels retrieved from enterprise configuration repositories, and appending the semantic enrichment metadata to the structured event representations for use during correlation and risk computation.
